(19) United States
(12) Patent Application Publication
(10) Pub. No.: US 2018/0372271 A1
(43) Pub. Date: Dec. 27, 2018

(54) Lubricant Collecting Device

(71) Applicant: Siemens Aktiengesellschaft, Muenchen (DE)

(72) Inventors: Georg BRUNNER, Ruhstorf (DE); Oliver MEMMINGER, Neuburg a.Inn (DE); Klaus SCHIFFERER, Neuburg am Inn (DE)

(21) Appl. No.: 15/540,451

(22) PCT Filed: Nov. 27, 2015
(86) PCT No.: PCT/EP2015/077878

§ 371 Date: Jun. 20, 2018

(30) Foreign Application Priority Data
Dec. 30, 2014 (DE) 10 2014 227 039.1

(51) Int. Cl. F16N 31/00; F16N 31/02; F16C 33/66; H02K 7/08; H02K 11/40; H02K 13/00

(52) U.S. Cl. CPC F16N 31/004; F16N 31/02; F16C 33/6622; H02K 7/08; H02K 11/40; H02K 7/183; F16N 2031/025; F16N 2210/14; F16N 2210/18; F16N 2210/20; F16N 2210/025; H02K 13/003

(57) ABSTRACT

A lubricant collecting device including a lubricant guide and a lubricant container, where the lubricant guide has an outer surface for guiding a first medium and an inner surface for guiding a second medium, and also includes a gap that forms an inlet for the first medium.

### CROSS-REFERENCE TO RELATED APPLICATIONS

This is a U.S. national stage of application No. PCT/EP2015/077878 filed 27 Nov. 2015. This application claims the priority of German application no. DE 102014227039 filed Dec. 30, 2014, the content of which is incorporated by reference in its entirety.

### BACKGROUND OF THE INVENTION

### 1. Field of the Invention

The invention relates to machine lubrication and, more particularly, to a lubrication collecting device.

### 2. Description of the Related Art

Bearings in machines can be lubricated by a lubricant. The design of the bearing can result in lubricant leakage. The machine is, for example, a gear, an electric motor, an electrical generator, provided, for example, in a wind power plant to generate electrical energy. The electrical motor or electrical generator are electrical machines.

### SUMMARY OF THE INVENTION

It is an object of the invention to collect leaking lubricant.

This and other objects and advantages are achieved in accordance with the invention by a lubricant collecting device, a bearing or an electrical machine.

A lubricant collecting device comprises a lubricant guide and a lubricant container. The lubricant guide guides lubricant into the lubricant container. Lubricant is, for example, grease or oil. The lubricant guide has an outer surface for guiding a first medium and an inner surface for guiding a second medium. Both the first medium and the second medium are in particular lubricant, where the first medium is in particular a lubricant that is different from the second medium.

In one embodiment of the lubricant collecting device, the lubricant guide includes a gap that forms an inlet for the first medium. Preferably, the gap is chosen large enough to enable the expected quantity of lubricant to pass through the gap. The gap in particular has a width of from 1 mm to 5 mm. A gap that is too large enables the ingress of unwanted foreign bodies.

In another embodiment of the lubricant collecting device, the lubricant guide comprises a grease shaft and a grease-shaft end portion. The grease shaft in particular has a square cross section. The gap is in particular wholly or partially formed between the grease shaft, in particular an outer surface of the grease shaft, and the grease shaft end portion. The grease-shaft end portion is in particular used for the attachment of the lubricant container. The lubricant container is, for example, made of a metal or a plastic. If the lubricant container is made of metal, it is grounded in one embodiment.

In a further embodiment of the lubricant collecting device, the outer surface and the gap form a first route for the first medium to the lubricant container. This first route is in particular used to conduct oil. The inner surface of the shaft forms a second route for the second medium to the lubricant container. The second medium is, for example, grease or also oil. Thus, the first medium flowing along the outer surface of the shaft flows into the same container as the second medium flowing along the inner surface of the shaft.

In yet another embodiment of the lubricant collecting device, the lubricant container comprises electrically conductive material and is grounded. To this end, the container comprises a grounding strap to which a grounding cable is attached.

In an embodiment of the lubricant collecting device, the lubricant container is electrically insulated. This is achieved, for example, by the use of plastic to form the container and/or to coat the container. In this way, the need to ground the container is eliminated.

In an embodiment of a bearing in accordance with the invention, the bearing can be lubricated via a lubricant, where the bearing comprises a lubricant collecting device. The lubricant collecting device is in particular formed in the manner described.

In one embodiment of the bearing, the bearing comprises a grease chamber cap, where the grease chamber cap is connected to the lubricant collecting device such that lubricant can enter the lubricant container as the first medium and/or second medium. The collection of lubricant in the container enables contamination of the bearing or the object in which the bearing is used to be reduced. Objects of this kind are, for example, an electric motor or an electric generator.

Thus, an electrical machine, such as a motor or a generator, comprises a bearing with a lubricant, in particular with a grease chamber. It is particulary possible for grease to be guided via a slinger ring at least indirectly into the lubricant collecting device. Therefore, the medium for lubrication travels from the location of the lubrication in bearing to the lubricant container. Here, the medium flows along an outer surface and/or an inner surface of a lubricant shaft.

In an embodiment of an electrical machine in accordance with the invention, the lubricant collecting device is positioned in or on a slip-ring housing.

In an embodiment of the electrical machine, the lubricant container is grounded by a bearing shield of the electrical machine.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The following describes the invention by way of example with reference to figures, in which:

FIG. 1 shows a lubricant collecting device on an electrical machine in accordance with the invention;

FIG. 2 shows a second perspective depiction of the lubricant collecting facility in accordance with the invention;

FIG. 3 shows a third perspective depiction of the lubricant collecting facility in accordance with the invention;

FIG. 4 shows a cross section of the lubricant collecting facility;

FIG. 5 shows a top view of the lubricant collecting facility in accordance with the invention;

FIG. 6 shows a lubricant container held by holding tongues, and

FIG. 7 shows a further cross section of the lubricant collecting device in accordance with the invention.

### DETAILED DESCRIPTION OF THE EXEMPLARY EMBODIMENTS

In the following figures, identical elements have the same reference numbers.

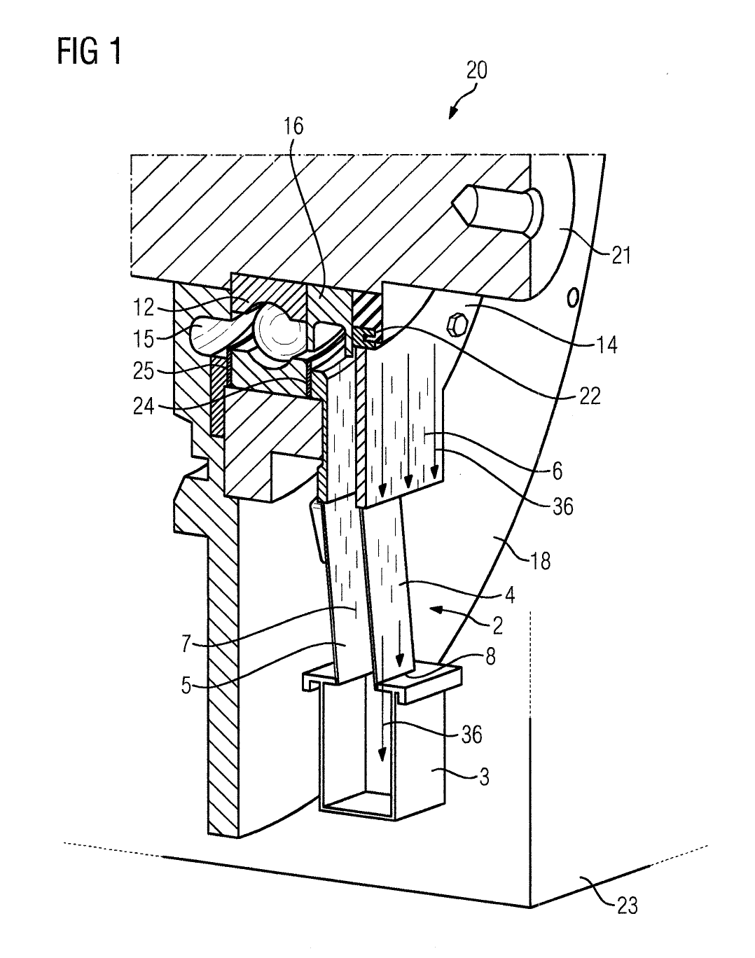

The depiction in FIG. 1 shows a lubricant collecting device on an electrical machine 20 of which a section is shown. The electrical machine 1 comprises a shaft 21, a bearing 12 and a bearing shield 18. The bearing 12 is electrically insulated via electrical insulators 24 and 25. Grease passes through a grease chamber 15 and a slinger ring 16 to a grease chamber cap 14, which is sealed by a labyrinth seal 22. Lubricant, such as grease, is guided via a lubricant guide 2 into a lubricant container 3. The lubricant guide 2 comprises at least one grease shaft, which is a kind of hollow body. Lubricant can flow in both the internal and external regions of the grease shaft. The lubricant flow direction is indicated by arrows 36.

Lubricant in the external region is a first medium 6, which is collected in the lubricant container 3. Lubricant in the internal region of the lubricant guide 2 is a second medium 7, which is collected in the lubricant container 3. The internal region contains inner surfaces 5 and the outer region contains outer surfaces 4. A grease container shaft 2 with an integrated grease container 3, i.e., the lubricant container, is provided to collect or guide the first medium 6 and the second medium 7. A gap 8 is provided to collect the first medium 6, which is in particular leakage oil and is located on the outer region. Therefore, leakage oil is to be collected in the outer region of the grease container and guided from the outside to the grease container 3. The grease container 3 should be integrated and lockable on the grease shaft 2. The grease container 3 is, for example, used to collect and remove old grease on wind generators, motors and similar applications with relubricating systems. This avoids the risk of a failure to collect leakage oil in the outer region grease containers that are permanently connected to the grease shaft, as can be the case with the wind generators, for example.

There are various embodiments of the grease container, for example containers mounted on the generator housing or a container that is permanently fastened with screws. In FIG. 1, the grease container 3, i.e., the lubricant container, is located in a slip-ring housing 23. The leakage oil on the exterior of the grease shaft 2 is returned to the integrated grease container 3 via a, in particular circumferential, gap 8 in the grease shaft 2. The gap 8 is implemented, for example, by a welded-on interim plate between an upper part of the grease shaft 2 and a lower part of the grease shaft 2. The plate is, for example, edged and slotted. A wholly or partially circumferential gap 8 ensures that the first medium 6 is collected.

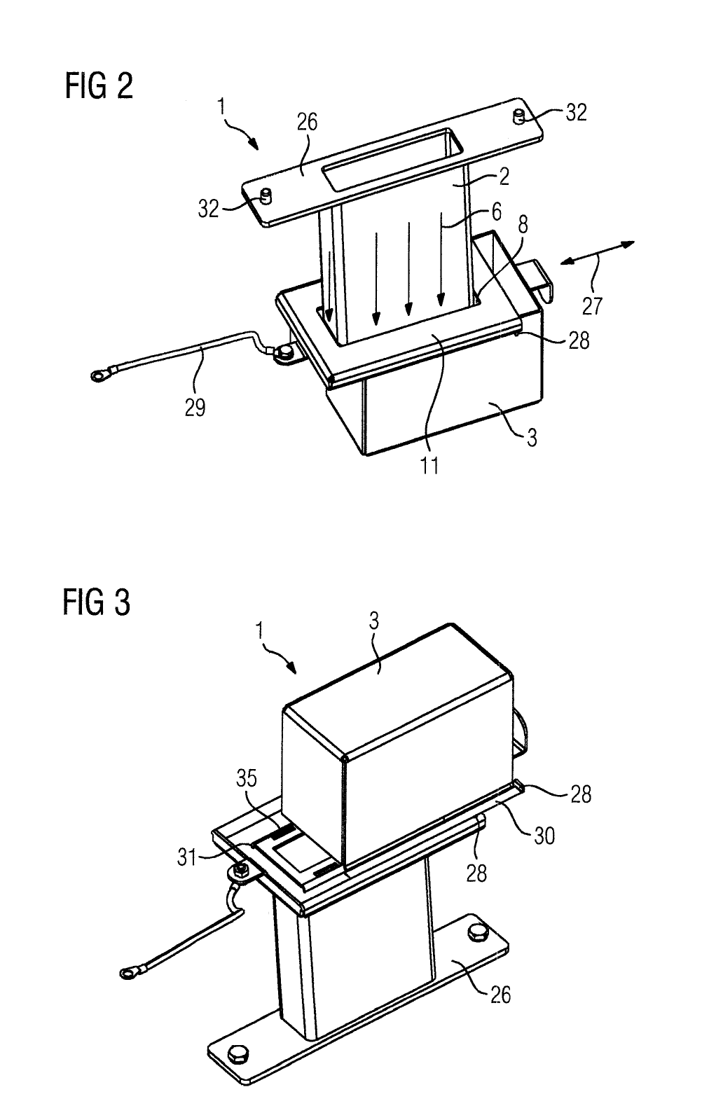

The depiction in FIG. 2 shows a lubricant collecting device 1 with a lubricant guide 2 in the form of a grease shaft with a grease shaft flange 26 and screws 32 for the fixation thereof. A first medium 6 can pass from the outside via the gap 3 into the container 3. The container 3 can be pushed into a grease-shaft end portion 11, as depicted by an arrow 27. The container 3 can be locked by locking elements 28. A grounding wire 29 is screwed onto the grease shaft end portion 11.

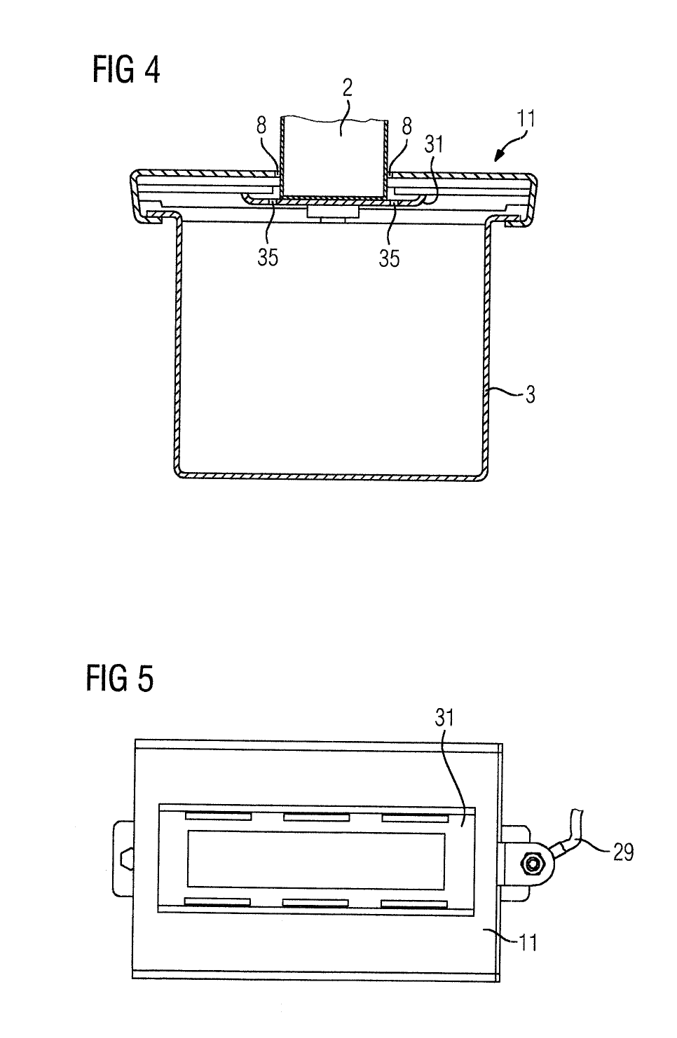

The depiction in FIG. 3 shows a lubricant collecting device 1 that is rotated in comparison with FIG. 2. This enables a better depiction of a guide 30 for the container 3. This also depicts an interim plate 31 with openings 35 to allow passage of the medium entering via the gap 8. The interim plate 31 is used to fix the grease-shaft end portion, which is also shown in FIG. 4.

The depiction in FIG. 4 shows a steel grease container 3 on the grease shaft 2. These are integrated with one another. The grease container 3 is pushed into the grease shaft by two zinc-coated bars. The grease container is locked via gravitational force by two straps on the grease container 3. These latch, for example, into the grease shaft 2. Therefore, as shown, the container 3 is held on the grease-shaft end portion 11 by an interim plate 31. Oil, water or grease can pass into the container 3 from the outside through the gap 8 and openings 35 in an interim plate 31.

The depiction in FIG. 5 is a top view of the interim plate and the grease-shaft end portion 11 together with the screwed-on grounding wire 29. The grease container 3 is, for example, grounded a zinc-coated strap for the grounding wire 29 and the zinc-coated contact surfaces between the guide rails from the grease shaft 2 to the grease container 3.

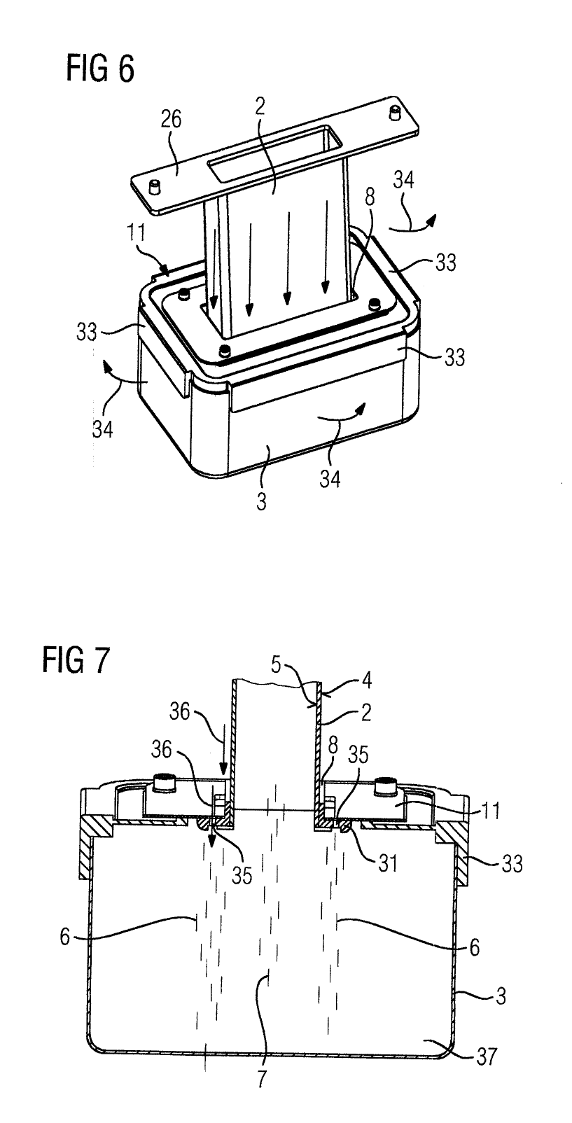

The depiction in FIG. 6 shows a container 3 made of plastic, which is held on the grease shaft end portion 11 by hinged holding tongues 33. The holding tongues 33 can be opened by rotary movements 34. In the depiction in FIG. 6, the plastic container 3 is integrated on the grease shaft 2, where the container 3 is clipped-on using a clip system by the holding tongues 33. The grounding can occur via by grounding points to be provided on the grease shaft.

The depiction in FIG. 7 shows a cross section of the clipped-on grease container 3 that is already filled with a quantity 37 of a collected medium. A medium can pass from the outside through the gap 8 and the opening 35 in the interim plate 31 into the container 3. Therefore, it is particularly possible for leakage oil from the outside on the grease shaft 2 to be introduced into the container 3. In this case, the lubricant collecting device can in particular be formed in several parts. This in particular comprises at least the grease shaft and the grease container. Advantageously, there are no parts that can be lost, thus achieving an easy-to-service configuration.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A lubricant collecting device comprising:
a lubricant guide having an outer surface for guiding a first medium and an inner surface for guiding a second medium; and
a lubricant container.

14. The lubricant collecting device as claimed in claim 13, wherein the lubricant guide includes a gap which forms an inlet for the first medium.

15. The lubricant collecting device as claimed in claim 13, wherein the lubricant guide comprises a grease shaft and a grease-shaft end portion, wherein the gap is formed between the grease shaft and grease-shaft end portion.

16. The lubricant collecting device as claimed in claim 14, wherein the lubricant guide comprises a grease shaft and a grease-shaft end portion, wherein the gap is formed between the grease shaft and grease-shaft end portion.

17. The lubricant collecting device as claimed in claim 13, wherein a first route for the first medium to the lubricant container is formed via the outer surface and the gap; and
wherein a second route for the second medium to the lubricant container is formed via the inner surface.

18. The lubricant collecting device as claimed in claim 14, wherein a first route for the first medium to the lubricant container is formed via the outer surface and the gap; and
wherein a second route for the second medium to the lubricant container is formed via the inner surface.

19. The lubricant collecting device as claimed in claim 15, wherein a first route for the first medium to the lubricant container is formed via the outer surface and the gap; and
wherein a second route for the second medium to the lubricant container is formed via the inner surface.

20. The lubricant collecting device as claimed in claim 13, wherein the lubricant container comprises electrically conductive material and is grounded.

21. The lubricant collecting device as claimed in claim 13, wherein the lubricant container is electrically insulated.

22. A bearing lubricated via a lubricant, wherein the bearing comprises the lubricant collecting device as claimed in claim 13.

23. The bearing as claimed in claim 22, wherein the bearing comprises a grease chamber cap, wherein the grease chamber cap is connected to the lubricant collecting device such that lubricant can enter the lubricant container as at least one of (i) the first medium and (ii) the second medium.

24. An electrical machine comprising the bearing as claimed in claim 22, wherein the bearing comprises a grease chamber.

25. An electrical machine comprising the bearing as claimed in claim 23, wherein the bearing comprises a grease chamber.

26. The electrical machine as claimed in claim 12, wherein grease is guidable into the lubricant collecting device via a slinger ring.

27. The electrical machine as claimed in claim 12, wherein the lubricant collecting device is positioned in a slip-ring housing.

28. The electrical machine as claimed in claim 26, wherein the lubricant collecting device is positioned in a slip-ring housing.

29. The electrical machine as claimed in claim 12, wherein the lubricant container is grounded by a bearing shield.

30. The electrical machine as claimed in claim 26, wherein the lubricant container is grounded by a bearing shield.

31. The electrical machine as claimed in claim 27, wherein the lubricant container is grounded by a bearing shield.
